(19) United States
(12) Patent Application Publication
(10) Pub. No.: US 2008/0106470 A1
(43) Pub. Date: May 8, 2008

(54) Multi-Branch Conductive Strip Planar Antenna

(75) Inventors: Chuan-Lin Hu, Taipei County (TW); Chia-Sheng Liu, Taipei County (TW); Yu-Wei Chen, Taipei County (TW); Chang-Lun Liao, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHANT SINCERE CO., LTD., Taoyuan County (TW)

(21) Appl. No.: 11/556,260

(22) Filed: Nov. 3, 2006

(51) Int. Cl. H01Q 9/04; H01Q 1/38

(52) U.S. Cl. 343/700 MS

(57) ABSTRACT

A multi-branch conductive strip planar antenna is disclosed herein, which is basically a planar antenna with a radiator and a ground plane fed by a transmission line. Specifically, the radiator is composed of a plurality of taper-comb-shaped multi-branch conductive strips. Thus, a broadband antenna can be achieved through a plurality of coupled circuits and a plurality of current paths in the taper-comb-shaped conductive strips.

### BACKGROUND OF THE INVENTION

1. Field of the Invention

The present invention relates generally to a planar antenna, and in particular to a planar monopole antenna that has multi-branch conductive strips.

2. The Prior Arts

The traditional thin monopole antenna has a simple structure and a lot of advantages, such as vertical polarization and omnidirectional in a horizontal plane. Therefore it is often used in mobile phones or other mobile devices. The primary disadvantage of the antenna is its narrow bandwidth. In the past, the common way to increase the bandwidth of the thin monopole antenna is to thicken the antenna, such as conical monopole antenna and skeletal conical monopole antenna, and so on. The other means to increase the bandwidth include using load resistance or antenna folding. Compared with the thin monopole antenna, these monopole antennas appear bulky.

For the past ten more years, a broadband planar monopole antenna is developed to replace the thin monopole antenna. Due to asymmetric structure of the planar monopole antenna, a radiation pattern within a radiation frequency band changes a lot. Especially in a high frequency band, a main beam is unable to keep an omnidirectional characteristic in a horizontal direction and in a vertical direction. These affect practical applications.

However, the planar antenna has the advantages of lightweight, compact size, easy manufacture, easy attachment and easy integration. Therefore applications are extensive. The planar antennas are suitable for application in wireless communication and wireless broadband system.

Generally, the methods to increase the bandwidth are using a thick dielectric substrate with a low dielectric constant, piling structure, parasitic component, or passive components such as slot, slit, integrated impedance load, chip resistance or capacitance and so on. The methods to reduce the antenna volume include using a short circuit pin, passive component (such as plate capacitance, chip capacitance or chip resistance), and slot and so on to change the current path or the antenna matching characteristics on the sheet metal.

In a word, in order to reduce the antenna volume and meet the demand of digital video broadcast and digital audio broadcast (DVB/DAB) reception on UHF band (470-860 MHz) and VHF band (170-240 MHz), after long and painstaking thought, the inventor proposes the present invention, that is a multi-branch conductive strip planar antenna. It is an antenna with a plurality of coupled circuits and a plurality of current paths, which achieves the broadband antenna.

### SUMMARY OF THE INVENTION

A primary objective of the present invention is to provide a multi-branch conductive strip planar antenna. Due to a radiator having a plurality of multi-branch conductive strips, the working bandwidth of the antenna can cover VHF and the UHF band, and the volume of the antenna is reduced simultaneously. In addition, a passive component may be provided at the input end of the antenna to improve the efficiency by fine-tuning the digital broadcast frequency according to different nations.

Based on the objective mentioned above, the multi-branch conductive strip planar antenna according to the present invention uses the radiator on a substrate and a ground plane fed by a microstrip to stimulate. Specifically, the radiator is composed of a plurality of taper-comb-shaped multi-branch conductive strips. Thus, the antenna can achieve the objective of broadband through a plurality of coupled circuits and a plurality of current paths.

### BRIEF DESCRIPTION OF THE DRAWINGS

The present invention will be apparent to those skilled in the art by reading the following detailed description of preferred embodiments thereof, with reference to the attached drawings, in which:

FIG. 1A is a schematic view showing a multi-branch conductive strip planar antenna in accordance with a first embodiment of the present invention.

FIG. 1B is a graph showing the relation between frequency and return loss of the first embodiment of the present invention.

FIG. 2A is a schematic view showing a multi-branch conductive strip planar antenna in accordance with a second embodiment of the present invention.

FIG. 2B is a graph showing the relation between frequency and return loss of the second embodiment of the present invention.

FIG. 3A is a schematic view showing a multi-branch conductive strip planar antenna in accordance with a third embodiment of the present invention.

FIG. 3B is a graph showing the relation between frequency and return loss of the third embodiment of the present invention.

FIG. 4A is a schematic view showing a multi-branch conductive strip planar antenna in accordance with a fourth embodiment of the present invention.

FIG. 4B is a graph showing the relation between frequency and return loss of the fourth embodiment of the present invention.

FIG. 5A is a schematic view showing a multi-branch conductive strip planar antenna in accordance with a fifth embodiment of the present invention.

FIG. 5B is a graph showing the relation between frequency and return loss of the fifth embodiment of the present invention.

### DETAILED DESCRIPTION OF THE PREFERRED EMBODIMENT

In the following description, five embodiments are used to explain the spirit of the present invention. What should be noticed is that the strip widths and the spacing of multi-branch conductive strips may be the same as or different from one another. A person skilled in the art may adjust the lengths of the taper-comb-shaped multi-branch conductive strips, the number and location of the multi-branch conductive strips, and the location of a ground plane according to actual needs, such as antenna bandwidth, frequency, and radiation pattern, to achieve a better performance of the antenna.

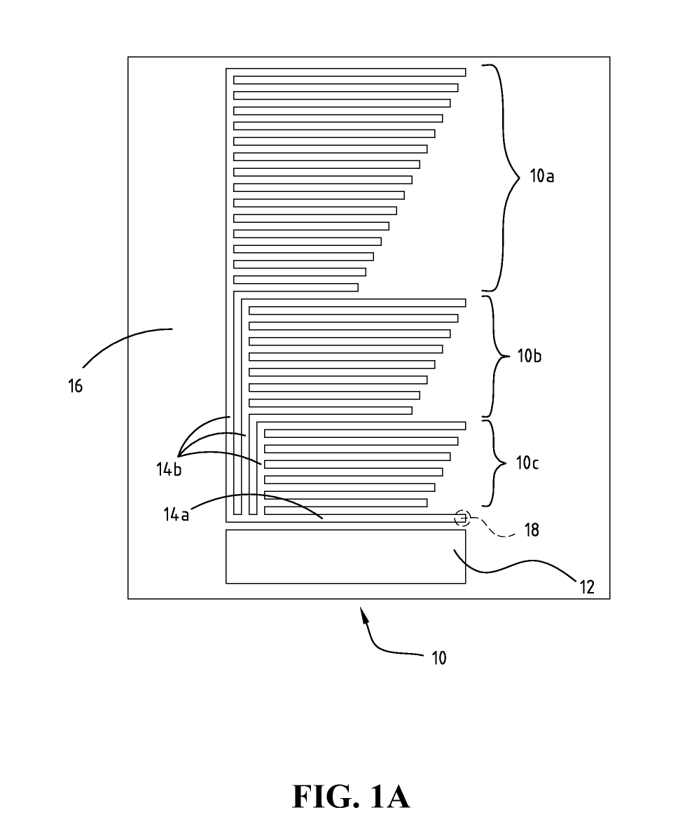

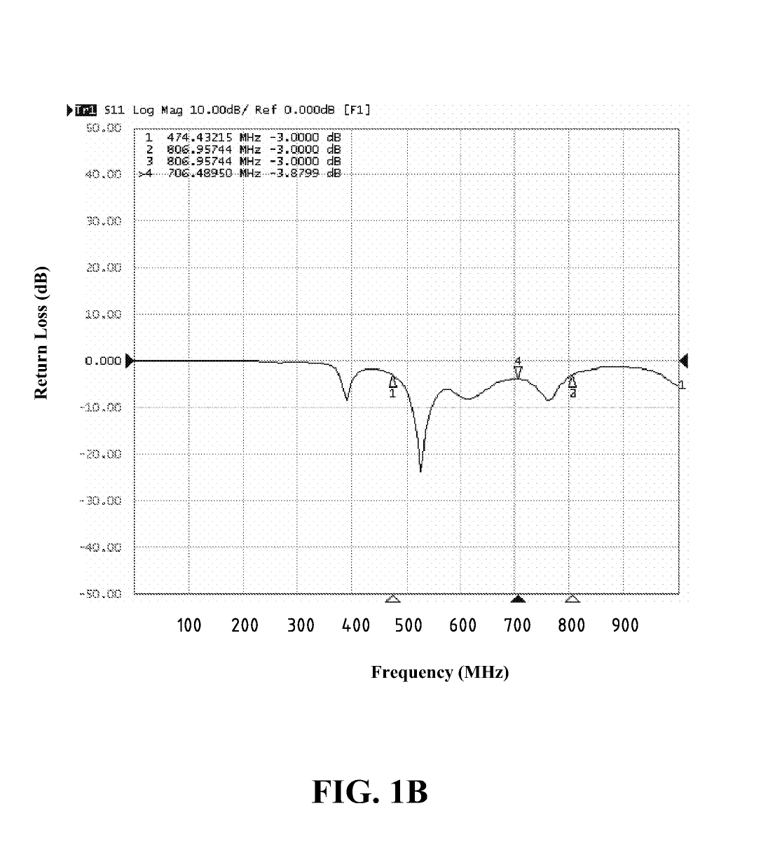

Referring to FIG. 1A, in a multi-branch conductive strip planar antenna 10 constructed in accordance with the present invention, a substrate 16 has a radiator and a ground plane 12. The radiator includes a plurality of taper-comb-shaped multi-branch conductive strips 10a, 10b, and 10c. The multi-branch conductive strips 10a, 10b, and 10c have different strip lengths and make the impedance bandwidth of the antenna 10 to satisfy UHF and VHF frequency band.

In addition to the radiator and the ground plane 12, the multi-branch conductive strip planar antenna 10 according to the present invention further comprises a feed circuit on the substrate 16. The feed circuit includes a feed section 14a and connection strip sections 14b, and electrically connects with the radiator. Where the feed section 14a connects with the connection strip sections 14b is usually a right angle. The signals from a microstrip (not shown) are fed into the multi-branch conductive strips 10a, 10b, and 10c via a feed point 18 of the feed section 14a and the connection strip sections 14b.

The ground plane 12 and the multi-branch conductive strips 10a, 10b, and 10c may produce a coupling effect to reduce the antenna volume. Therefore the ground plane 12 can be placed not only by the multi-branch conductive strips 10a, 10b, and 10c as shown in FIG. 1A, but also on the side of the substrate 16 without the radiator (i.e. on the reverse side of the radiator).

In summary, the multi-branch conductive strips 10a, 10b, and 10c electrically connected with the connection strip sections 14b produce a plurality of current paths of different lengths. It makes the antenna 10 have resonance effects of multi-frequency band and broadband. Specifically speaking, in this kind of current path structure, a current distribution in a short current path resonates at a high frequency band, and a current distribution in a long current path resonates at a low frequency band. The taper-comb-shaped multi-branch conductive strips have different strip lengths. Therefore the antenna 10 has the resonance effects of multi-frequency band and broadband.

FIG. 1B is a drawing showing the relation between the return loss of the antenna 10 and the frequency in accordance with the first embodiment, and wherein the ordinate axis stands for return loss (unit is decibel (dB)), and the abscissa axis stands for the frequency (the unit is million hertz, MHz). FIG. 1B illustrates that the antenna 10 approximately can cover the UHF (470-860 MHz) band and the VHF (170-240 MHz) band for the reception of Digital Video Broadcast (DVB) and Digital Audio Broadcast (DAB) at −3 dB return loss.

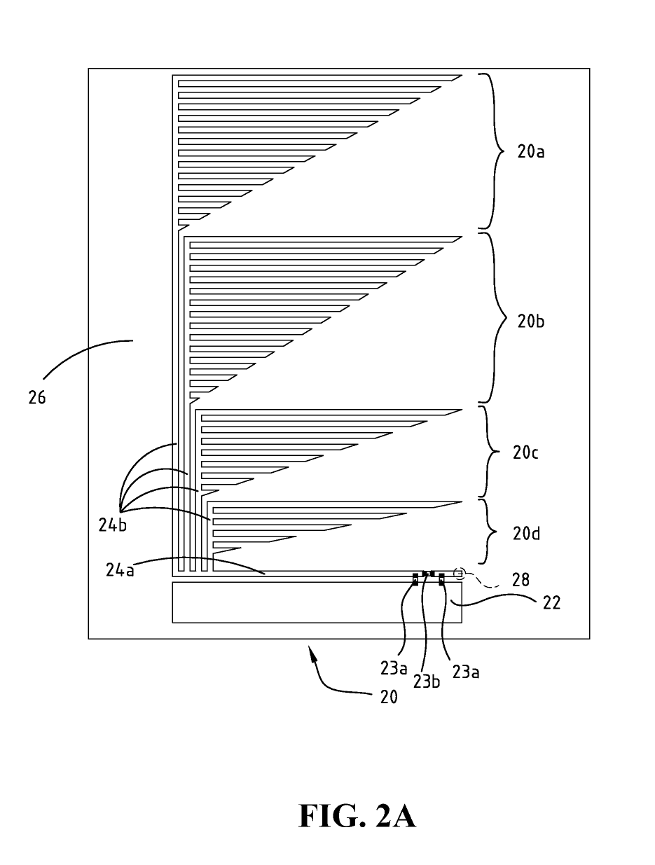

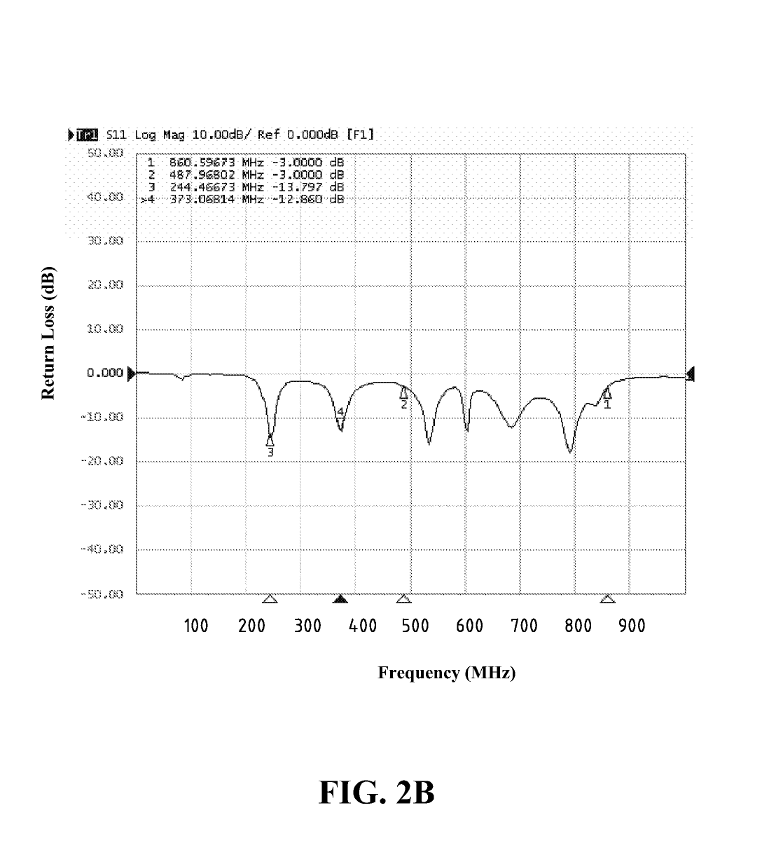

As shown in FIG. 2A, tapered shapes of multi-branch conductive strips 20a, 20b, 20c, and 20d according to a second embodiment of the present invention are shaper than those of the first embodiment. Therefore, the multi-branch conductive strips 20a, 20b, 20c, and 20d are arranged in shapes of right triangles and have slanted ends. Compared with the first embodiment, the multi-branch conductive strips 10a, 10b, and 10c are arranged in shapes of trapezoids and have rectangular ends. An antenna 20 constructed in accordance with the second embodiment also has a ground plane 22, a feed section 24a, connection strip sections 24b, a substrate 26, and a feed point 28. Their functions and relations between each other are the same as those of the first embodiment. FIG. 2B illustrates that the antenna 20 approximately can cover the UHF band and the VHF band for the reception of Digital Video Broadcast (DVB) and Digital Audio Broadcast (DAB) at −3 dB return loss.

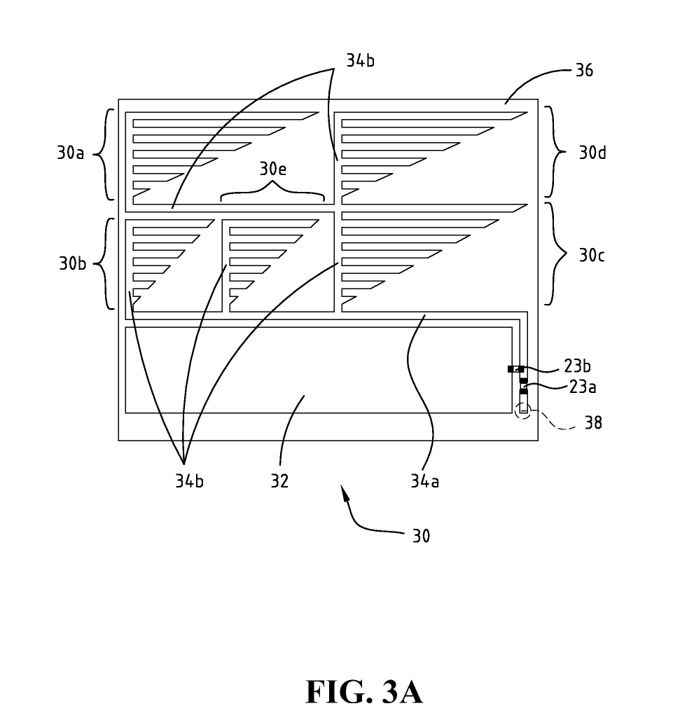

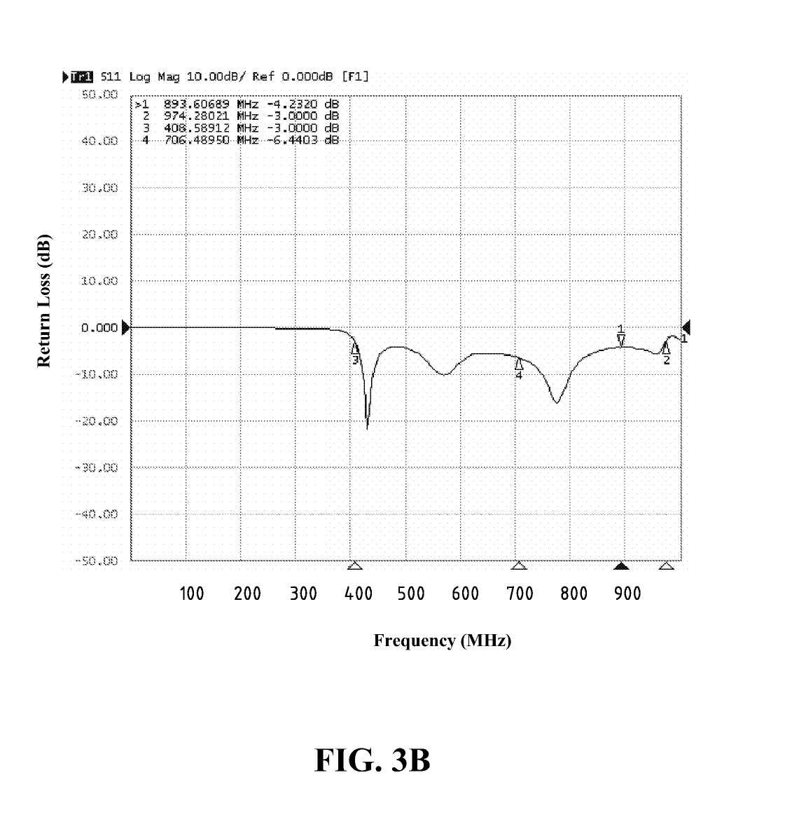

Compared with the second embodiment, multi-branch conductive strips 30a, 30b, 30c, 30d, and 30e according to a third embodiment of the present invention shown in FIG. 3A are also in sharp taper-comb shapes, but unlike the second embodiment, they have fewer branches. Moreover, the arrangement of the taper-comb-shaped multi-branch conductive strips 30a, 30b, 30c, 30d, and 30e on the substrate 36 is different from that arranged in series according to the second embodiment. The taper-comb-shaped multi-branch conductive strips 30a, 30b, 30c, 30d, and 30e are arranged parallel to or perpendicular to each other, and all their sizes are not the same. The antenna 30 according to the third embodiment also has a ground plane 32, a feed section 34a, connection strip sections 34b, a substrate 36, and a feed point 38. FIG. 3B illustrates that the antenna 30 approximately can cover the UHF band and the VHF band for the reception of Digital Video Broadcast (DVB) and Digital Audio Broadcast (DAB) at −3 dB return loss.

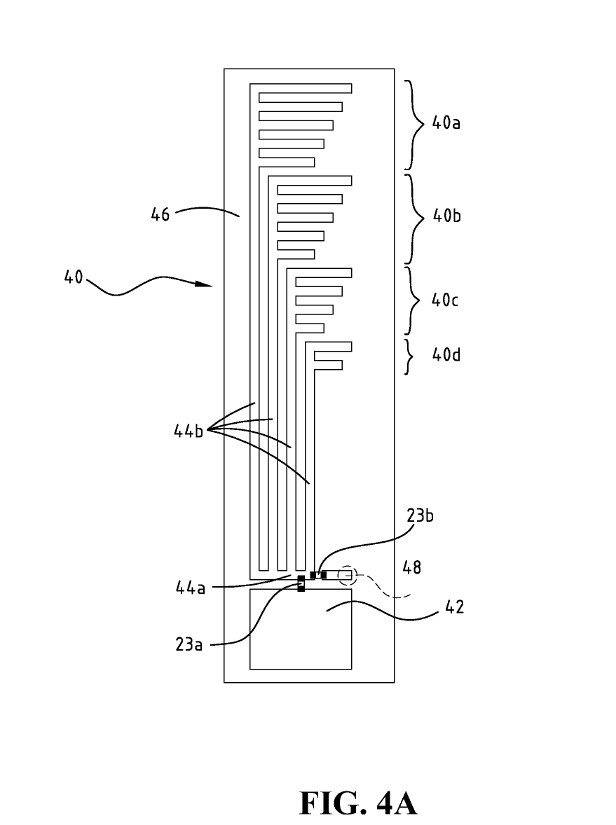

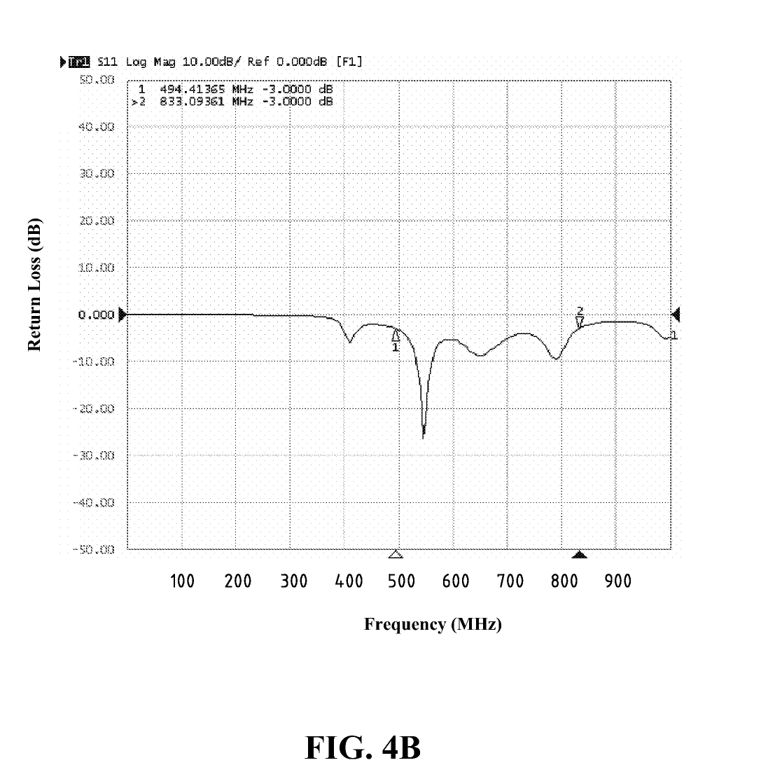

As shown in FIG. 4A, tapered shapes of multi-branch conductive strips 40a, 40b, 40c, and 40d in accordance with a fourth embodiment of the present invention are less sharp than those of the first embodiment. Compared with the first embodiment, the multi-branch conductive strips 40a, 40b, 40c, and 40d are also arranged in shapes of trapezoids but have fewer branches. The lengths of the multi-branch conductive strips 40a, 40b, 40c, and 40d are much shorter than those of the connection strip sections 44b. In addition, an antenna 40 according to the fourth embodiment also has a ground plane 42, a feed section 44a, connection strip sections 44b, a substrate 46, and a feed point 48. FIG. 4B illustrates that the antenna 40 approximately can cover the UHF band and the VHF band for the reception of Digital Video Broadcast (DVB) and Digital Audio Broadcast (DAB) at −3 dB return loss.

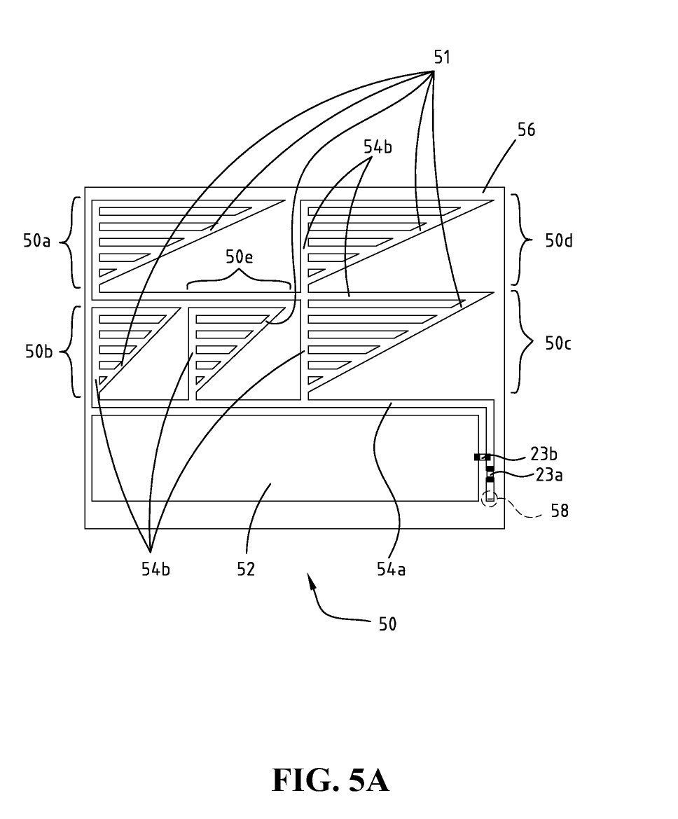

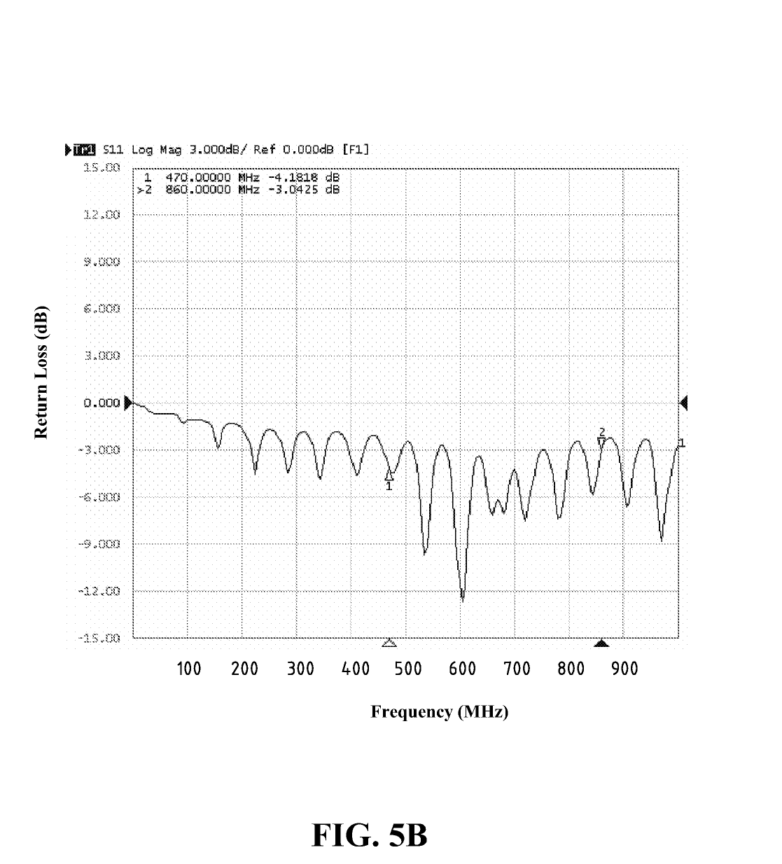

Compared with the third embodiment, multi-branch conductive strips 50a, 50b, 50c, 50d, and 50e in accordance with a fifth embodiment of the present invention as shown in FIG. 5A, further comprise conduction portions 51 to electrically connect with the ends thereof. The tapered shapes of the multi-branch conductive strips 50a, 50b, 50c, 50d, and 50e are sharper than those of the third embodiment. Compared with the second embodiment, the multi-branch conductive strips 50a, 50b, 50c, 50d, and 50e have fewer branches and their arrangement on a substrate 56 is different from that arranged in series according to the second embodiment. The multi-branch conductive strips 50a, 50b, 50c, 50d, and 50e are arranged parallel to or perpendicular to each other, and all their sizes are not the same. An antenna 50 comprises a ground plane 52, a feed section 54a, connection strip sections 54b, the substrate 56, and a feed point 58. FIG. 5B illustrate that the antenna 50 approximately can cover the UHF band and the VHF band for the reception of Digital Video Broadcast (DVB) and Digital Audio Broadcast (DAB) at −3 dB return loss.

In addition, a π circuit or a T circuit, which is a circuit composed of a capacitance 23a and an inductance 23b, may integrate with an input end of the feed section 14a, 24a, 34a, 44a, or 54a as disclosed in the Taiwan Pat. No. 574769 “multi-frequency resonator antenna device” to achieve the objective of resonating at different frequency bands.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A multi-branch conductive strip planar antenna, comprising:
a substrate having a ground plane and a radiator formed thereon, the radiator having a plurality of taper-comb-shaped multi-branch conductive strips;
wherein a transmission line is fed into the radiator and the ground plane on the substrate to achieve an effect of a broadband antenna.

2. The antenna as claimed in claim 1, wherein the antenna covers a UHF band and a VHF band for reception of Digital Video Broadcast and Digital Audio Broadcast.

3. The antenna as claimed in claim 1, wherein ends of the multi-branch conductive strips are rectangular or slanted.

4. The antenna as claimed in claim 1, wherein the antenna further comprises a feed circuit having a feed section and connection strip sections arranged on the substrate and electrically connected with the radiator; and the transmission line is connected with the multi-branch conductive strips via a feed point of the feed section and the connection strip sections.

5. The antenna as claimed in claim 1, wherein the ground plane is provided by the multi-branch conductive strips or on a side of the substrate without the radiator.

6. The antenna as claimed in claim 1, wherein the multi-branch conductive strips have the same or different strip widths.

7. The antenna as claimed in claim 1, wherein the multi-branch conductive strips have the same or different spacing between the strips.
